(19) United States
(12) Patent Application Publication
(10) Pub. No.: US 2008/0075919 A1
(43) Pub. Date: Mar. 27, 2008

(54) Wiring board and process for producing the same

(75) Inventors: Kuniaki SUZUKI, Miyagi-ken (JP); Hiroshi KUBOTA, Miyagi-ken (JP); Nobuaki HAGA, Miyagi-ken (JP); Kenichi MITSUMORI, Miyagi-ken (JP)

Correspondence Address: BEYER WEAVER LLP, P.O. BOX 70250, OAKLAND, CA, 94612-0250, US

(73) Assignee: ALPS ELECTRIC CO., LTD., Tokyo (JP)

(21) Appl. No.: 11/973,786

(22) Filed: Oct. 9, 2007

Related U.S. Application Data
(63) Continuation of application No. PCT/JP2006/307621, filed on Apr. 11, 2006.

(30) Foreign Application Priority Data
Apr. 15, 2005 (JP) 2005-118799

(51) Int. Cl. B32B 3/10; B05D 3/10

(52) U.S. Cl. 428/138; 427/305

(57) ABSTRACT

To provide a wiring board that permits the formation of a Cu plating layer maintaining sufficient adhesion to both a ceramic layer and a Ag connecting layer and a method for manufacturing the wiring board. [Solving means] Parts of the surface of the ceramic layer 12 and the upper surfaces of the Ag connecting layers 14 are covered with a Ag thin film layer 15. The Ag thin film layer 15 enhances a bonding strength between the Cu wiring layer 11 and the Ag connecting layer 14 and contributes to forming the Cu wiring layer 11 with a sufficient thickness on the ceramic layer 12 during a step of forming the Cu wiring layer 11 by electroless plating.

### CROSS REFERENCE TO RELATED APPLICATIONS

This application is a continuation of International Application No. PCT/JP2006/307621, filed Apr. 11, 2006, which is incorporated herein by reference in its entirety.

### TECHNICAL FIELD

The present invention relates to a wiring board including a ceramic layer having a circuit pattern composed of an electrically conductive material formed thereon and a process for producing the wiring board.

### BACKGROUND ART

There is known a wiring board having a laminated structure in which a circuit is formed on each of a plurality of ceramic layers, and the circuits on these layers are electrically connected to each other with electrically conductive connecting layers filling through holes called “contact holes.” An electroless plating method is usually applied to form a Cu wiring on such a non-conductive ceramic layer.

In order to perform electroless plating in a step of forming a Cu wiring on a ceramic layer, a catalyst for initiating a plating reaction should be added to an object to be plated (ceramic layer). Palladium is widely used as a catalyst for electroless plating (Patent document 1).

Japanese Unexamined Patent Application Publication No. 06-342979

### DISCLOSURE OF INVENTION

### Problem to be Solved by the Invention

However, when a Cu metal film, which is to be formed into a Cu wiring, is formed on a ceramic layer having contact holes filled with a Ag connecting layer by an electroless plating method using a palladium catalyst in the usual manner, there is the problem that high adhesion cannot be secured between the surface of the Ag connecting layer and the Cu metal film.

This is caused by corrosion of Ag in a substitution reaction that proceeds due to a difference in ionization between Ag (silver) and Pd (palladium) in the electroless plating process using a palladium catalyst. Therefore, a corrosion layer is formed between the surface of the Ag connecting layer and the Cu metal film, thereby failing to obtain sufficient adhesion therebetween. If the concentration of the palladium catalyst is low, a deposition efficiency of a Cu plating film on a ceramic layer is degraded, while the corrosion of the Ag is suppressed, and thus the Cu plating film having a sufficient thickness cannot be formed on both the surface of the Ag connecting layer and the ceramic layer.

In view of the situation described above, the present invention has been achieved, and the present invention provides a wiring board that permits the formation of a Cu plating layer having sufficient adhesion to both a ceramic layer and a Ag connecting layer and also provides a method for manufacturing the wiring board.

### Means for Solving the Problems

To achieve the above-mentioned object, the present invention provides a wiring board including a ceramic layer, a contact hole formed in the ceramic layer, a Ag connecting layer formed to fill the contact hole, a Ag thin film layer formed to cover a surface of the Ag connecting layer and at least a part of a surface of the ceramic layer, and a Cu wiring layer deposited on the Ag thin film layer so that at least a part of the Cu wiring layer is electrically connected to the Ag connecting layer.

The Cu wiring layer may be deposited by electroless plating using the Ag thin film layer as a catalyst. The ceramic layer may be made from a low temperature co-fired ceramic.

Also, the present invention provides a method for manufacturing a wiring board including the steps of forming a contact hole in a ceramic layer, depositing a Ag connecting layer to fill the contact hole, depositing a Ag thin film layer to cover at least a part of a surface of the ceramic layer and a surface of the Ag connecting layer using a processing solution containing a silver catalyst, depositing a Cu layer to cover a surface of the Ag thin film layer by electroless plating and removing a part of the Cu layer and Ag thin film layer to form a Cu wiring layer constituting a circuit pattern.

### Advantages of the Invention

According to the laminated wiring board of the present invention, since a processing solution containing a Ag catalyst is used to deposit a Cu wiring layer, a Ag thin film layer having the same ionization tendency as a Ag connecting layer is formed. Therefore, even if the Ag catalyst is excessively contained in the solution, the Cu layer can be bonded firmly to the Ag thin film layer 15 and the Cu wiring layer can be deposited to a sufficient thickness on an upper surface of a ceramic layer.

### BRIEF DESCRIPTION OF THE DRAWINGS

FIG. 1 is a schematic cross sectional view of a constitution of a laminated wiring board according to an embodiment of the present invention.

FIG. 2 is an enlarged cross sectional view of a main part of a wiring board 10 shown in FIG. 1.

FIG. 3 is a view illustrating a method for manufacturing a wiring board of the present invention.

FIG. 4 is an enlarged microscopic photograph of an example of a wiring board of the present invention.

FIG. 5 is an enlarged microscopic photograph of an existing wiring board made as a comparative example.

### REFERENCE NUMERALS

10 wiring board

11 Cu wiring layer

12 ceramic layer

13 contact hole

14 Ag connecting layer

15 Ag thin film layer

16 Ag wiring layer

### BEST MODE FOR CARRYING OUT THE INVENTION

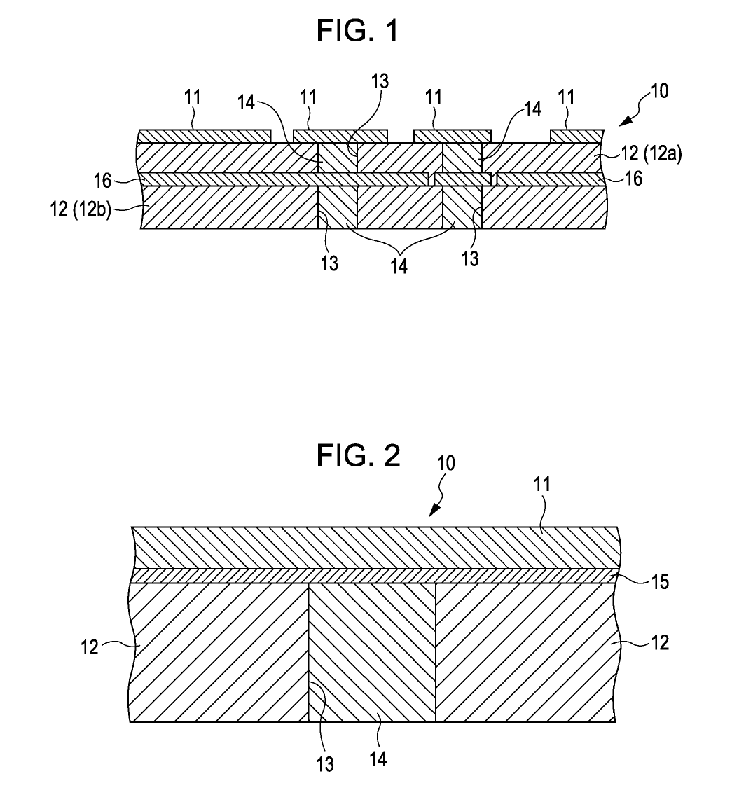

Here, an embodiment of the present invention will be now described with reference to the drawings. FIG. 1 is a schematic cross sectional view of a laminated wiring board according to an embodiment of the present invention. A laminated wiring board 10 made by laminating a plurality of ceramic layers 12, each of which has a Cu wiring layer 11 forming a predetermined wiring pattern on a surface thereof. The ceramic layers 12 may be made from, for example, a low-temperature co-fired ceramic (LTCC) material.

Contact holes 13 are formed at prescribed positions to pass through the ceramic layers 12 in the thickness direction. Then Ag connecting layers 14 are deposited to fill the contact holes 13. The Ag connecting layers 14 electrically connect the Cu wiring layer 11 on a first ceramic layer 12a to a Ag wiring layer 16 on a second ceramic layer 12b.

As a matter of course, various electronic components (not shown) may be connected to the Cu wiring layer 11.

FIG. 2 is an enlarged cross sectional view of a main part that is near the surface of the wiring board 10 shown in FIG. 1. Parts of the surface of the ceramic layer 12 and the upper surface of the Ag connecting layer 14 are covered with a Ag thin film layer 15. The Cu wiring layer 11 is deposited on the Ag thin film layer 15 that is formed on the ceramic layer 12 and the Ag connecting layer 14. The Ag thin film layer 15 enhances the bonding strength between the Cu wiring layer 11 and the Ag connecting layer 14 and contributes to forming the Cu wiring layer 11 with a sufficient thickness on the ceramic layer 12 during a step of forming the Cu wiring layer 11 by electroless plating.

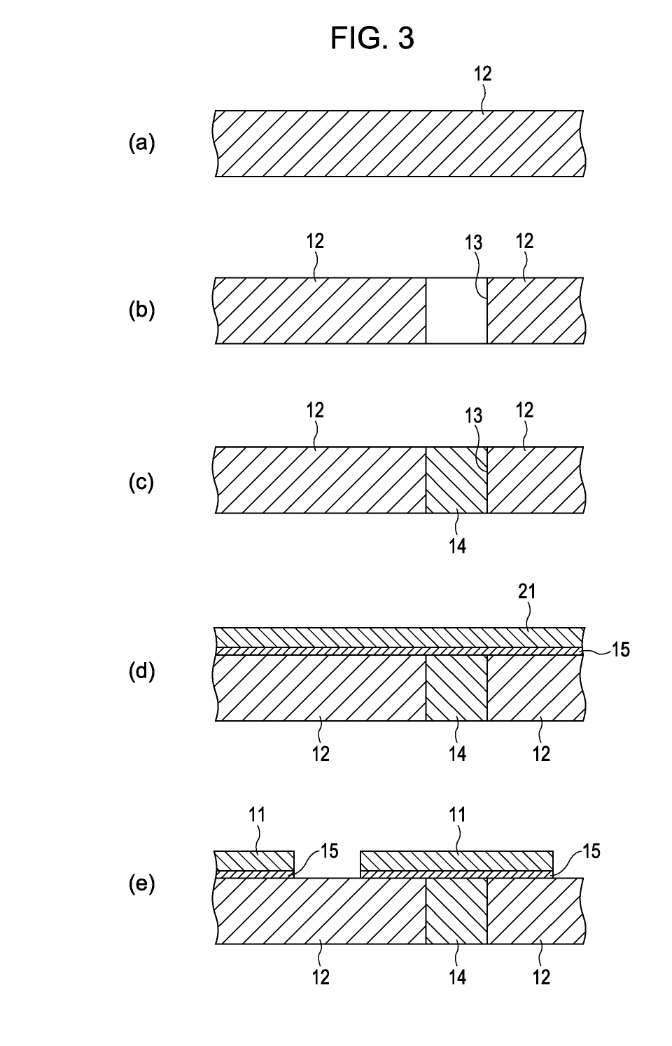

Next, a method for manufacturing a wiring board of the present invention will be described with reference to FIG. 3. In manufacturing the wiring board of the present invention, first, a ceramic layer 12 is formed (FIG. 3a). The ceramic layer 12 may be made of, for example, low-temperature co-fired ceramic (LTCC). Next, at prescribed position on the ceramic layer 12, contact hole 13 that passes through the ceramic layer 12 is formed by, for example, etching (FIG. 3b).

Ag connecting layer 14 that fills the contact hole 13 is formed by, for example, depositing a mask layer on areas except on the contact hole 13 formed by the above-mentioned process (FIG. 3c). As for depositing the Ag connecting layer 14, for example, Ag paste may be applied to fill the Ag connecting layer by screen-printing.

Then, a Cu layer 21 is deposited as a source layer of the Cu wiring layer 11 over the entire surface of the ceramic layer 12 having the Ag connecting layer 14 formed therein. For depositing the Cu layer 21, Cu electroless plating using a Ag catalyst allows the Cu layer 21 to be electrolessly deposited on the ceramic layer 12 and the Ag connecting layer 14. This allows the Cu layer 21 to be deposited firmly on the upper surface of the Ag connecting layer 14 and the ceramic layer 12 with a Ag thin film layer 15 formed therebetween using Ag catalyst (FIG. 3d).

Conventionally, a Cu electroless plating method using a palladium catalyst has been used to deposit a Cu layer on a ceramic layer and a Ag connecting layer. However, when such a conventional Cu electroless plating method using a palladium catalyst is used, a corrosion layer is formed between a deposited Cu layer and a Ag connecting layer due to a difference in ionization between Ag and Pd. This causes the problem that the corrosion layer lowers the bonding strength between the Cu layer and the Ag connecting layer.

Note that, if the content of the palladium catalyst is reduced in order to suppress the formation of the corrosion layer, it leads to the problem of difficulty in the deposition of the Cu layer with a desired thickness on the ceramic layer.

According to the present invention, since the Cu electroless plating method using the Ag catalyst is used to deposit the Cu layer 21, the Ag thin film layer 15 that has the same ionization tendency as the Ag connecting layer 14 is formed. Therefore, even if the Ag catalyst is sufficiently contained, the Cu layer 21 can be bonded firmly to the Ag thin film layer 15 and the Cu layer 21 can be deposited with a sufficient thickness on the upper surface of the ceramic layer 12.

The Cu wiring layers 11 are formed into prescribed patterns on the Ag thin film layer 15 over the upper surface of the Ag connecting layer 14 and ceramic layer 12 by forming a mask layer with the prescribed pattern on the Cu layer 21 deposited through the above-mentioned process and then etching the Cu layer 21 (FIG. 3e).

To form a double-sided wiring board, the above-mentioned steps may be performed on both the surfaces. If required, a nickel-gold plating layer may be formed on the Cu layer 21. Further, in order to enhance the bonding strength between the ceramic layer 12 and the Cu layer 21, a method may be applied for imparting roughness to the surface of ceramic layer or depositing a nickel plating film on the surface of ceramic layer using the Ag thin film layer 15 as a catalyst and then forming the Cu layer 21 on the nickel plating film by electroless Cu plating.

### EXAMPLE

The applicant verified the effect of the wiring board of the present invention. In the verification, alumina substrates were used as ceramic layers and wiring boards of an example of the present invention were made according to the method for manufacturing the wiring board of the present invention described in Table 1.

TABLE 1
Ag-based catalyst process (Okuno Chemical Industries Co., Ltd.)

| | | Concentra- | | Tempera- | Processing | | |
|---|---|---|---|---|---|---|---|
| Step | Chemical | tion | | ture | time | | Remarks |
| Alkaline degreasing | C-4000 | 50 | g/L | 50° C. | 3 | min | |
| | (C. Uyemura & | | | | | | |
| | Co., Ltd.) | | | | | | |
| Surface control | MOON-300 | 100 | mL/L | 60° C. | 5 | min | |
| Addition of Catalyst | MOON-500 | Concentrate | | RT | 5 | min | |
| | | solution | | | | | |
| Activating | MOON-600 | 100 | mL/L | 45° C. | 5 | min | |
| Electroless Cu | MOON-700 | | | 45° C. | 30 | min | Desired plating thickness |
| plating | | | | | | | of 2 μm |
| Antitarnishing | AT-21 | 10 | mL/L | RT | 0.5 | min | Air blow-drying |
| | (C. Uyemura & | | | | | | |
| | Co., Ltd.) | | | | | | |

As Comparative Example, alumina substrates were used as ceramic layers and wiring boards of a conventional example (Comparative Example) were made according to an existing method for manufacturing a wiring board described in Table 2.

TABLE 2
Pd-based catalyst process (C. Uyemura & Co., Ltd.)

| | | Concentra- | | Tempera- | Processing | | |
|---|---|---|---|---|---|---|---|
| Step | Chemical | tion | | ture | time | | Remarks |
| Alkaline degreasing | Asahi | 50 | g/L | 50° C. | 3 | min | |
| | Cleaner | | | | | | |
| | C-4000 | | | | | | |
| Sensitizing 1 | Sensitizer | 100 | mL/L | RT | 3 | min | |
| | S-10X | | | | | | |
| Activating 1 | Activator | 100 | mL/L | 30° C. | 2 | min | |
| | A-10X | | | | | | |
| Sensitizing 2 | Sensitizer | 100 | mL/L | RT | 2 | min | |
| | S-10X | | | | | | |
| Activating 2 | Activator | 100 | mL/L | 30° C. | 1 | min | |
| | A-10X | | | | | | |
| Accelerating | MEL-3-A | 50 | mL/L | RT | 1 | min | No water washing after |
| | | | | | | | accelerating |
| Electroless Cu plating | THRU-CUP | | | 36° C. | 48 | min | Desired plating thickness |
| | PEA ver. 2 | | | | | | of 2 μm |
| Antitarnishing | AT-21 | 10 | mL/L | RT | 0.5 | min | Air blow-drying |
| | (C. Uyemura & | | | | | | |
| | Co., Ltd.) | | | | | | |

The bonding strength between the Cu layer and the Ag layer (Ag connecting layer) was determined for each of the wiring boards of the above-mentioned example of the present invention (Ag-based catalyst) and the Comparative Example (Pd-based catalyst). The bonding strength was measured by the Sebastian method. The results obtained by the Sebastian method for measuring the bonding strength between the Cu layer and the Ag layer (Ag connecting layer) are shown in Table 3.

TABLE 3

| | Measurement | | Reduced | Average |
|---|---|---|---|---|
| | result | | value | value |
| | (Kg/cm²) | Breaking mode | (MPa) | (MPa) |
| Pd-based | 56 | Detachment | 5.714 | 3.673 |
| catalyst | | between Cu and Ag | | |
| | 10 | Detachment | 1.020 | |
| | | between Cu and Ag | | |
| | 42 | Detachment | 4.286 | |
| | | between Cu and Ag | | |
| Ag-based | 373 | Breaking of | >38.061 | 44.728 |
| catalyst | | substrate | | |
| | 373 | Breaking of | >38.061 | |
| | | substrate | | |
| | 569 | Breaking of | >58.061 | |
| | | substrate | | |

According to Table 3, Example of the present invention (Ag-based catalyst) did not show any detachment of the Cu layer from the Ag layer (Ag connecting layer) even with the breaking strength of the board (38.061 MPa). This indicates that there is no probability of detachment of the Cu layer from the Ag layer (Ag connecting layer) with anticipated vibrations or impacts.

On the other hand, in Comparative Example (Pd-based catalyst) using the conventional process showed detachment of the Cu layer from the Ag layer (Ag connecting layer) at a relatively low strength of 3.673 MPa on average. This indicates that a failure of connection between the Cu layer and the Ag layer (Ag connecting layer) may occur by detachment caused by vibrations or impacts in ordinary use.

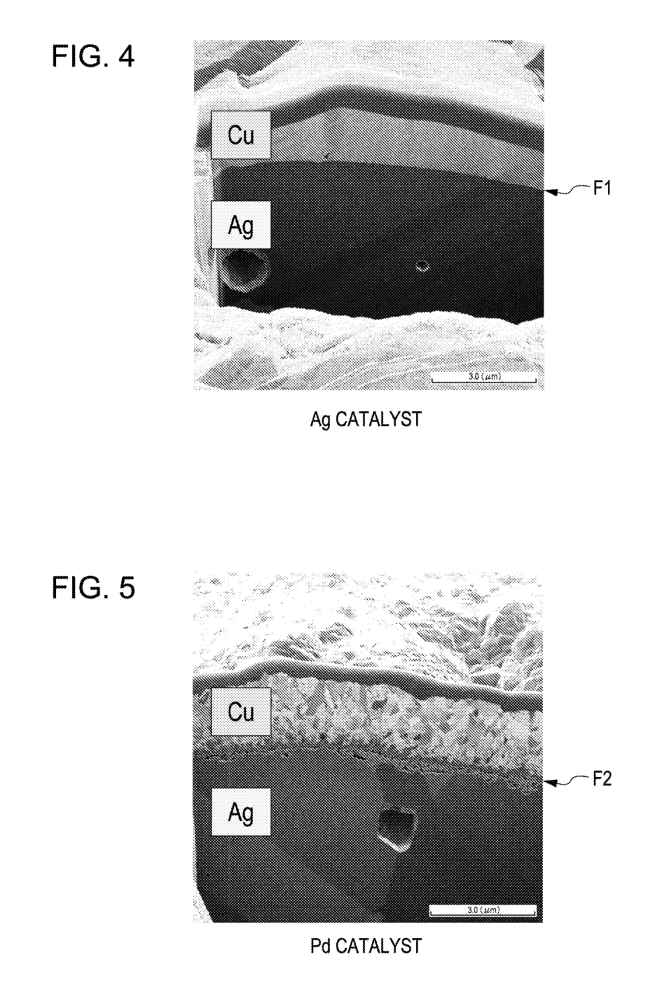

Next, enlarged microscopic photographs near the boundaries between the Cu layer and the Ag layer (Ag connecting layer) of the wiring boards of the above-mentioned example of the present invention (Ag-based catalyst) and the comparative example (Pd-based catalyst) are shown in FIGS. 4 and 5, respectively.

In Example of the present invention (Ag-based catalyst) shown in FIG. 4, there is no corrosion in the Ag layer near the boundary (FI) between the Cu layer and the Ag layer (Ag connecting layer), and it is found that the Cu layer and the Ag layer (Ag connecting layer) are bonded firmly. On the other hand, in Comparative Example (Pd-based catalyst) shown in FIG. 5, corrosion of the Ag layer caused by the Pd catalyst occurred in the vicinity of the boundary (F2) between the Cu layer and the Ag layer (Ag connecting layer), and it is found that the Cu layer and the Ag layer (Ag connecting layer) are not bonded firmly and can become easily detached.

1. A wiring board comprising a ceramic layer, a contact hole formed in the ceramic layer,
a Ag connecting layer formed to fill the contact hole, a Ag thin film layer formed to cover a surface of the Ag connecting layer and at least a part of a surface of the ceramic layer,
and a Cu wiring layer deposited on the Ag thin film layer by electroless plating using the Ag thin film layer as a catalyst so that at least a part of the Cu wiring layer conducts to the Ag connecting layer.

2. The wiring board according to claim 1, wherein the ceramic layer is made of a low temperature co-fired ceramic.

3. A method for manufacturing a wiring board, comprising the steps of forming a contact hole in a ceramic layer, depositing a Ag connecting layer to fill the contact hole,
depositing a Ag thin film layer to cover at least a part of a surface of the ceramic layer and a surface of the Ag connecting layer using a processing solution containing a silver catalyst, depositing a Cu layer to cover a surface of the Ag thin film layer by electroless plating using the Ag thin film layer as a catalyst, and removing parts of the Cu layer and Ag thin film layer to form a Cu wiring layer forming a circuit pattern.
